(19) United States
(12) Patent Application Publication
(10) Pub. No.: US 2007/0021877 A1
(43) Pub. Date: Jan. 25, 2007

(54) Systems and methods of redistribution of articles of commerce

(76) Inventors: William A. McDonough, Charlottesville, VA (US); Bernard J. David, Greenville, DE (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/448,901

(22) Filed: Jun. 8, 2006

Related U.S. Application Data
(60) Provisional application No. 60/688,384, filed on Jun. 8, 2005.
(60) Provisional application No. 60/688,729, filed on Jun. 9, 2005.

(51) Int. Cl. G05D 1/00

(52) U.S. Cl. 701/1

(57) ABSTRACT

A method includes transporting with a vehicle to a first location a first article addressed to a recipient associated with the first location. The first article is deposited at the first location. A second article that includes a technical nutrient is retrieved from the first location. The second article is transported with the vehicle to an intake node of a mail delivery network. The second article is transported via the mail delivery network to one of a plurality of geographically separated intake nodes of a technical nutrient redistribution network. Alternatively, the second article may include a biological nutrient or a biotechnical nutrient, and the redistribution network is a biological nutrient or biotechnical nutrient redistribution network.

### CROSS-REFERENCE TO RELATED APPLICATIONS

This application claims priority to provisional patent application No. 60/688,384, filed Jun. 8, 2005, entitled “Systems and Methods of Redistribution of Articles of Commerce,” and provisional patent application No. 60/688,729, filed Jun. 9, 2005, entitled “Systems and Methods of Redistribution of Articles of Commerce,” the disclosures of which are hereby incorporated by reference in their entirety.

### BACKGROUND OF THE INVENTION

The invention relates generally to recycling and reverse logistics, and more particularly to methods of re-distribution of physical articles of commerce.

There has been an increased focus on recycling and reducing waste headed for landfills, both by governmental entities and private industries. There are many environmental concerns related to the increase of material sent to landfills, as well as the concern over possible toxic chemicals from the discarded items, such as discarded electronic products.

There are other possible paths for discarding physical articles of commerce other than sending them to a landfill. For example, some articles can be recycled, such as products constructed with plastics, glass, and cardboard. Some communities provide for curb-side pickup of discarded products to be recycled. There are also locations that will accept discarded products at a drop-off center, such as discarded cellular telephones. Unfortunately, there are often limits on the type of products typically accepted with a curb-side or drop-off recycling service. Typically, the types of articles accepted for recycling are packaging materials, in which other products were previously contained. Thus, products such as cell phones and electronic products are typically not accepted.

There are recycling processors in the business of collecting used products and processing them such that the processed product can be used in another new product. Unfortunately, because of undesirable chemical constituents typically present in many products, recycling usually means downcycling. In other words, recycling of a product typically means that the product will be processed for use in some other product of lesser value. Thus, there is a loss of value of the material through the recycling process. In some cases, discarded items are resold in the resale market, such as through on-line auction facilities such as eBay, and thrift shops or second hand stores. Again, there are often problems associated with getting products to such an entity.

Although there are some existing systems that provide for return of physical articles of commerce for purposes of recycling, there are economic downfalls present in many of those systems. For example, the costs associated with picking up used products (e.g., physical articles of commerce) from individual user and/or business locations can be high. The entity picking up the products from individual users and businesses may limit the geographic locations for which it is willing to travel. Also, drop-off sites for used products can be inconvenient for individual users and/or businesses.

Another, unrelated problem is one associated with mail carriers, most notably the United States Postal Service (USPS). The USPS is obligated to deliver mail to essentially every residence and business across the US, and also delivers a large amount of marketing materials and advertisements while picking up from each serviced address a relatively smaller amount of mail. These factors lead to the USPS deploying a large fleet of delivery vehicles, each of which is typically loaded to greater capacity at the beginning of a delivery route (when leaving the post office facility) than at the end of the route (upon return to the post office facility). Thus, each vehicle has substantial unused load carrying capacity. If the USPS could pick up and carry more mail or other materials along a vehicle's route, it would have the ability to generate additional revenue with little or no associated cost (e.g. without having to deploy larger or additional vehicles).

Accordingly, there is a need for systems and methods for facilitating the redistribution of a physical article of commerce after it has been discarded by a user.

### SUMMARY OF THE INVENTION

A method includes transporting with a vehicle to a first location a first article addressed to a recipient associated with the first location. The first article is deposited at the first location. A second article that includes a technical nutrient is retrieved from the first location. The second article is transported with the vehicle to an intake node of a mail delivery network. The second article is transported via the mail delivery network to one of a plurality of geographically separated intake nodes of a technical nutrient reprocessing network. Alternatively, the second article may include a biological nutrient or a biotechnical nutrient, and the redistribution network is a biological nutrient or biotechnical nutrient redistribution network.

### BRIEF DESCRIPTION OF THE DRAWINGS

FIG. 1A is a schematic illustration of a system according to an embodiment of the invention.

FIG. 1B is a schematic illustration of a carrier network.

FIG. 2 is a schematic illustration of a system according to an embodiment of the invention.

FIG. 3 is a schematic illustration of a system according to an embodiment of the invention.

FIG. 4 is a schematic illustration of a system according to another embodiment of the invention.

FIG. 5 is a schematic illustration of a system according to another embodiment of the invention.

FIG. 6 is a schematic illustration of a system according to another embodiment of the invention.

FIG. 7 is a schematic illustration of a system according to another embodiment of the invention.

FIG. 8 is a flow chart illustrating a method according to an embodiment of the invention.

FIG. 9 is a flow chart illustrating a method according to an embodiment of the invention.

FIG. 10 is a flow chart illustrating a method according to an embodiment of the invention.

### DETAILED DESCRIPTION

The invention provides solutions to the problems associated with the post user disposal of physical articles of commerce. As discussed above, there is an increased desire to recycle used products or physical articles of commerce, but limited avenues for getting the used products to an entity equipped to reprocess it such that some or all of the article can be reused in another product. The type of material that a product is constructed with will dictate whether some or all of the product can be recycled. There are a variety of different materials that are commonly recycled, such as many plastics, glass, and cardboard. This application will focus on the recycling and redistribution of physical articles of commerce that are constructed with at least a portion of what is called a “technical nutrient” material.

A “technical nutrient” material as that term is used herein is a material of human artifice designed to circulate within an industrial cycle, more than one time, and potentially endlessly. It is thus a material appropriate for use in an industrial closed-loop system, that is, a system where an item is manufactured, used, recovered and re-manufactured, continually. A technical nutrient material is therefore recyclable. A recyclable item is typically referred to as an item that is capable of being processed such that one or more materials used to make the item can be reused in some other lower valued form. The item is effectively what is sometimes referred to as “downcycled.” Recyclable as used herein refers to the ability to process an item after its initial use by a end user and use the item as raw material or feedstock for manufacture of a similar item or another product that makes a similarly high valued use of the material (rather than a lower-valued use). As an example, a technical nutrient material can be a polymer, such as polyester. At the end of its useful life, the polyester can be returned to an industrial process for reuse intact and/or for repolymerization. Preferably, the polyester is processed only with chemicals that are optimized for human and ecological health. Some specific product examples of technical nutrient materials include Victor Innovatex—Eco Intelligent Polyester™ (a synthetic textile), Shaw Eco Solution Q™ (a nylon 6 yarn) and Ecoworx™ (a polyolefin-based thermoplastic, PVC-free backing). Some metals, e.g. iron, are also suitable.

A “biological nutrient” as that term is used herein is a material usable by living organisms or cells to carry on life processes such as growth, cell division, synthesis of carbohydrates, and other complex functions. Biological nutrient materials are typically carbon-based compounds and can biodegrade naturally. Biological nutrients are typically comprised of materials that are rapidly renewable, naturally biodegradable, and all constituents of the material are deemed to be ecologically safe. A naturally biodegradable material is one that poses no immediate or eventual hazard to living systems, and can be used for human purposes and safely returned to the environment to feed the ecological processes. A biological nutrient material disintegrates (breaks down into minute particles and/or into its constituent molecular or atomic components) in common environmental conditions (i.e. in the presence of air and/or water within the temperature range of, for example liquid water) over a time frame that is environmentally appropriate (e.g. over a period of days or weeks, but less than years). Examples of biological nutrient materials include essentially any plant material such as cellulose fibers (e.g. cotton, flax, ramie), plant-based starches, or animal material (animal dermis, gut, hair or wool) and some metals (e.g. iron). A specific product example of a biological nutrient material is Climatex® Lifecycle™ fabric (an organically grown ramie combined with wool). The biological nutrient material is preferably processed only with chemicals that are optimized for human and ecological health.

Materials that would not normally be considered to be naturally biodegradable include most mineral-based materials (e.g. glass), and corrosion-resistant metals (e.g. stainless steels, aluminum). Other examples of, and explanation of the concepts of, technical and biological nutrients are set forth in W. McDonough and M. Braungart, Cradle to Cradle (North Point Press, 2002), the disclosure of which is hereby incorporated by reference in its entirety.

A “bio-technical” or hybrid nutrient material includes properties of both a technical nutrient material and a biological nutrient material. Thus, a bio-technical nutrient material is a material capable of either being recycled for reuse at a high value in an industrial process cycle or being naturally biodegraded. Examples of bio-technical nutrient materials include Cargill Dow's Natureworks™ (a resin made from renewable resources such as corn) and Ingeo™ (a synthetic fiber derived from renewable resources).

To set up an effective recycling or redistribution program, problems dealing with reverse logistics need to be addressed. Reverse logistics involves the transportation and distribution of physical articles of commerce after the user is ready to discard it. A system and method is needed for getting a used product to a processing facility that can sort, categorize, and/or transfer the product to the appropriate processor, such as a recycling facility, a reprocessor, or a manufacturer. The costs of such a system is a major factor in recycling decisions, as well as user awareness of avenues available to place an article in a recycling distribution system. Often users do not send their used products to be recycled because of the inconvenience of taking the products to a drop-off location designated for that product. In addition, the costs of picking up used products from individual homes and/or businesses can be high, making it uneconomical for after market entities such as recycling processors, manufacturers, used product resale companies and the like.

One possible method of getting used products or used articles of commerce (hereinafter referred to as “articles”) to a recycling distribution network or redistribution network as referred to herein, is to utilize existing common carrier transporting methods and routes. Common carriers as used herein refers to any entity in the business of transporting mail, goods or other articles, or persons. Some common carriers (hereinafter referred to as “carrier”), such as the United States Postal Service (USPS), Federal Express (FedEx), and the United Parcel Service (UPS) transport mail (and thus can be referred to as mail carriers). Other carriers transport only articles of commerce, such as carriers that deliver goods to retail stores or between a manufacturer and a distribution outlet, and some carriers transport passengers, such as by aircraft, trains, and buses. All carriers can experience load imbalance where the out-going vehicle is loaded to a higher capacity than the return load. As stated previously, this is particularly true with some mail carriers, such as the USPS. Such entities have routes to individual homes and businesses to drop off and pick up mail and other articles in more geographic locations than typical carriers. One method of utilizing the excess capacity on a carrier delivery return route is to pick up more articles from individual homes and/or businesses, such that the return route is being put to more productive use. The carrier can charge a fee to manufacturers, recycling processors and the like for transporting the articles, creating revenue on what would otherwise be a less than full capacity load. In such a scenario, there would be minimal, if any, additional costs to the carrier since the transport vehicle is already scheduled to travel the designated route.

One implementation of how this would work involves the return of used cell phones. For example, a cellular telephone manufacturer may have a return program for its cellular telephones, instructing the customer/users on how to return their cellular telephones when they no longer have use for them. Instead of requiring the user to take the cellular telephone to a recycling collection facility, the manufacturer can arrange for pick up of the telephone directly from the user's home or business using a carrier, such as the USPS. The user can place the used telephone in their mailbox or other designated location and when the USPS carrier comes to that location to drop off mail, it can pick up the cellular telephone and transport it back to a local post office or other designated location. Thus, a carrier network, such as the USPS, can be utilized to transport used articles from individual homes and/or businesses to a location that will ultimately transfer the article to a redistribution network.

A “redistribution network” as used herein, refers to a network including multiple locations or “intake nodes” designated to collect and redistribute articles. Such a network may be designated for a single product or a single type of material, such as a single type of technical nutrient material. In other embodiments, the redistribution network may be associated with multiple products and/or materials. The redistribution network can include manufacturers, recycling processors, after market sales outlets, such as eBay, thrift stores, and charitable organizations. The network can include a variety of different entities working to collect articles and transfer the articles to an appropriate entity that can process and/or use the article. Ultimately, the goal is to enable at least some part of the article traveling through the redistribution network to be manufactured into another product and/or used or sold in commerce.

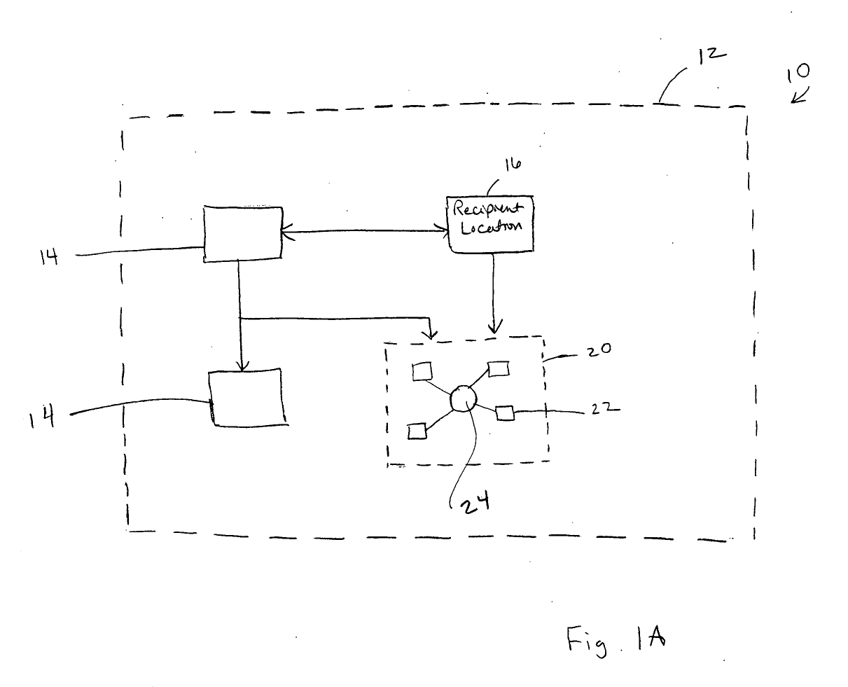

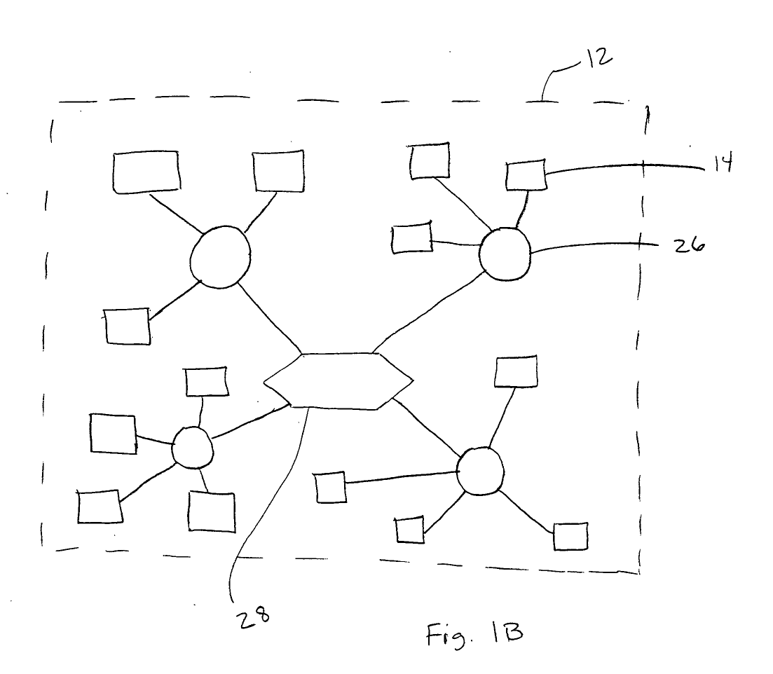

Turning now to the figures, FIG. 1A is a schematic illustration of a system and method according to an embodiment of the invention. A system 10 includes a carrier network 12, such as the USPS network, having a plurality of nodes 14 geographically distributed. The nodes can be local, terminal nodes (e.g., a local post office) and/or larger concentration nodes (e.g., a state post office) and/or even larger aggregation nodes (e.g., regional postal office). Although only two nodes 14 of the carrier network 12 are shown in FIG. 1, it should be understood that the carrier network 12 can have any number of nodes 14. For example, FIG. 1B is schematic illustration of a larger view of a portion of a carrier network 12, such as the USPS. A carrier network 12 can include a plurality of local nodes 14, which feed into concentration nodes 26, which can in turn feed into a larger aggregation node 28. At each of the nodes, the various articles of mail and/or other articles of commerce are typically sorted and re-routed, if necessary, to the appropriate geographically located node for delivery to a recipient.

As shown in FIG. 1A, the system 10 also includes at least one redistribution network 20, such as a technical nutrient redistribution network. The redistribution network 20 can include a plurality of geographically distributed intake nodes 22 and a plurality of collection nodes 24 (only one shown in FIG. 1A). The redistribution network 20 can include many levels of distribution facilities, including different node levels, similar to the network described above and shown in FIG. 1B. In the embodiment shown in FIG. 1A, a transport vehicle (vehicle) operated by a driver, picks up a first article, such as an article of mail, from a first node 14 of the carrier network 12 and delivers the first article of mail to a recipient location 16 for which the article is addressed. At the recipient location 16, the driver picks up a second article, such as a used physical article of commerce that the recipient has placed in their designated mailbox. The carrier driver then transports the second article via the vehicle back to the first node 14 of the carrier network 12. The second article is then transferred to a redistribution network 20. The second article can be transferred directly from the first node 14 to the redistribution network 20, or via a second node 14, as shown in FIG. 1. Alternatively, the second article can be picked up from the first node 14 (or the second node 14) by a vehicle associated with the redistribution network. In other embodiments, the vehicle can pick up the second article from the recipient location 16 and transport the second article directly to the redistribution network 20.

The systems and methods described herein are merely examples of how the principles of reverse logistic can be utilized to transport used articles of commerce. In practice, the systems can include much more complex distribution network logistics. For example, the routing logistics associated with transporting articles of commerce from individual homes or businesses and ultimately to a redistribution network can be very complex and would appropriately be managed by a computer system. Such a computer system can be configured, for example, to determine and select the appropriate redistribution network and intake node to transport the article, along with other typical transportation logistics.

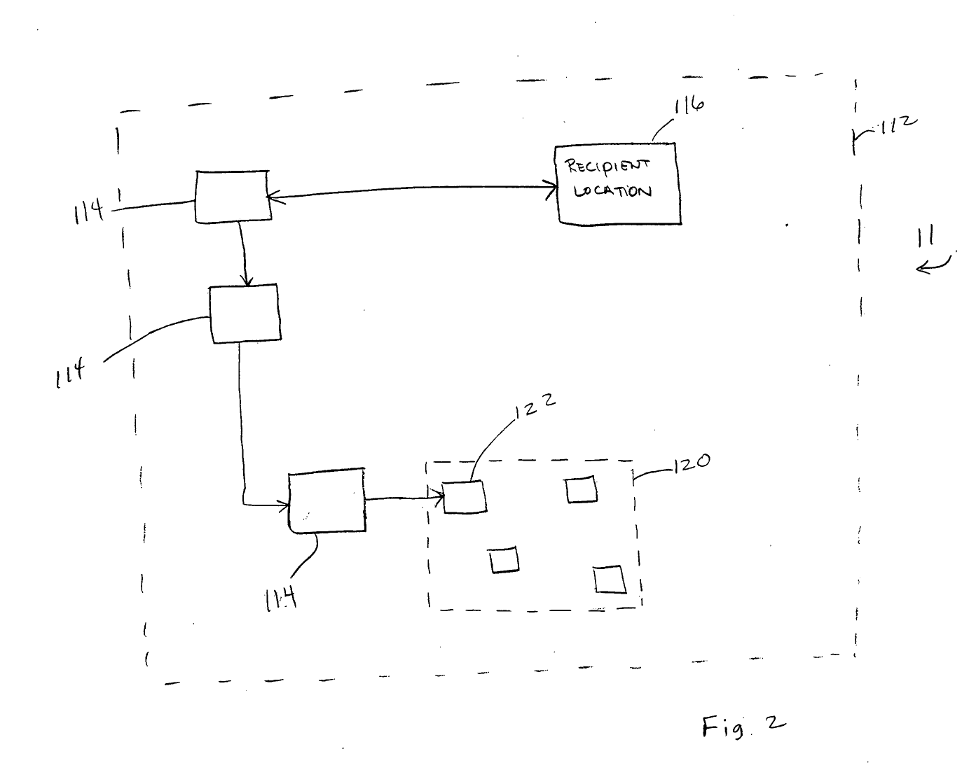

FIG. 2 is a schematic illustration of another embodiment of a system and method of the invention. A system 110 includes a carrier network 112 having a plurality of nodes 114. A redistribution network 120 is included, such as a redistribution network associated with a technical nutrient. The redistribution network 120 includes a plurality of geographically separated intake nodes 122. In this embodiment, the carrier driver delivers a first article of mail from a first node 114 to the recipient location 116 using a carrier vehicle, and picks up a second article from the recipient location 116. The driver transports the second article, via the vehicle, back to the first node 114 of the carrier network. The second article is then transported to a second node 114 (such as a concentration node) and then to a third node 114 of the carrier network 112, and then to a selected intake node of the plurality of intake nodes 122 associated with the redistribution network 120.

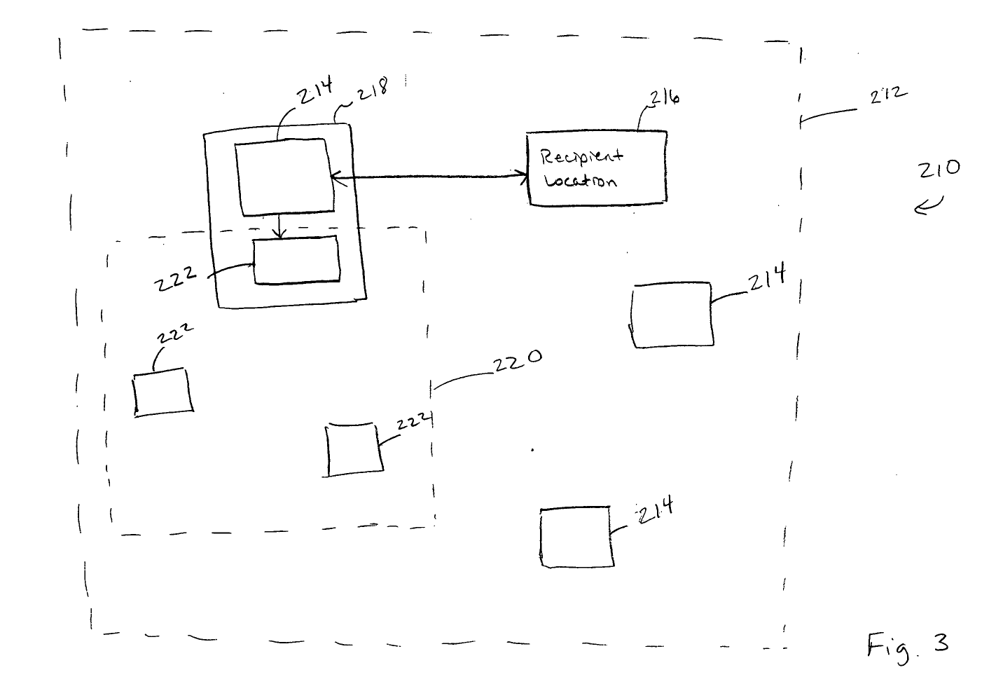

FIG. 3 is a schematic illustration of another embodiment of a system and method according to the invention. A system 210 includes a carrier network 212 having a plurality of nodes 214, and a redistribution network 220 having a plurality of geographically separated intake nodes 222. As with the previous embodiments, a carrier driver transports, with a vehicle, a first article of mail from a first node 214 to a recipient location 216, and picks up a second article from the recipient location 216. The driver transports the second article from the recipient location 216 back to the first node 214 via the vehicle. In this embodiment, at least one intake node of the plurality of intake nodes 222 is co-located with the first node 214 at co-location 218. Thus, the second article can be transferred to the intake node 222 (and the redistribution network 220) at the co-location 218. By way of example, the intake node 222 may be co-located with a post office, where the intake node 222 is a dedicated bin or other temporary collection storage space.

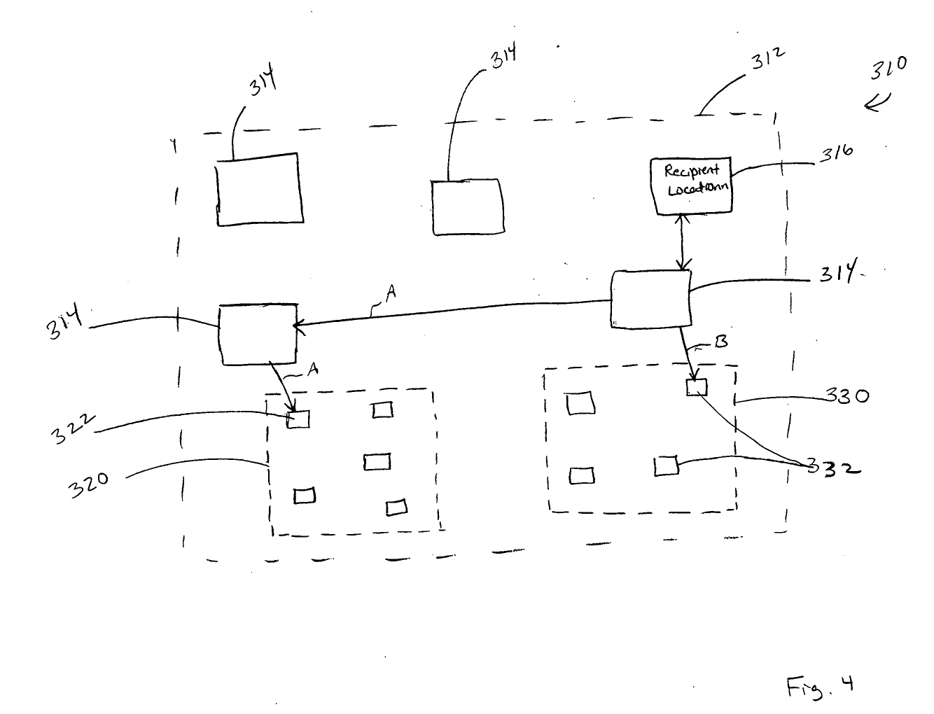

FIG. 4 illustrates yet another system and method of the invention. A system 310 includes a carrier network 312 having a plurality of nodes 314. The system 310 also includes a first redistribution network 320 having a plurality of geographically separated intake nodes 322, and a second redistribution network 330 having a plurality of geographically separated intake nodes 332. The first redistribution network 320 is associated with a first technical nutrient material and the second redistribution network 330 is associated with a second technical nutrient material. In other words, the first and second redistribution networks 320 and 330, respectively, include a network of entities involved in the recycling, reprocessing, and/or remanufacturing of a specific technical nutrient material and/or products including a specific technical nutrient material.

In this embodiment, a first article of mail is transported from a first node 314 of the carrier network 312 to a recipient location 316. A second article and a third article are picked up from the recipient location 316 and transported back to the first node 314. The second article includes a first technical nutrient material and the third article includes a second technical nutrient material. The first and second technical nutrient can be the same or different from each other. At the first node 314, a determination is made as to which of the plurality of intake nodes 322 associated with the first technical nutrient the second article is to be transported. The second article is then transported to the selected intake node 322 of the first technical nutrient network 320 via a route A as shown in FIG. 4. A determination is made as to which of the plurality of intake nodes 332 associated with the second technical nutrient the third article is to be transported. The third article is then transported to the selected intake node 322 of the second technical nutrient redistribution network 330 via a route B. FIG. 4 illustrates route A from the first node 314 to the first technical nutrient redistribution network 320 via a second node 314, and route B from the first node 314 directly to the second technical nutrient distribution network 330. These routes are merely example routes of the possible routes for transporting articles between a carrier network and a redistribution network. A route for a given article can depend on many factors, including the type of material the article is constructed, the geographic location of an intake node associated with the article, and the cost of transportation to a particular node.

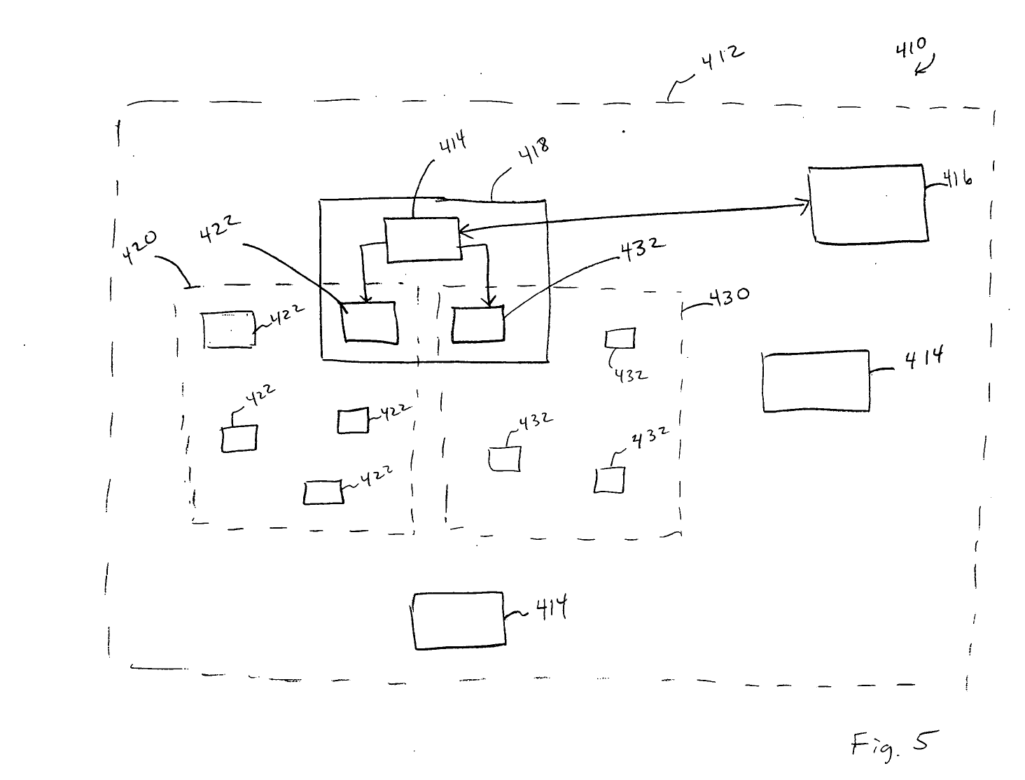

FIG. 5 illustrates a similar system and method as shown in FIG. 4, except in FIG. 5 there are two technical nutrient redistribution networks each having an intake node co-located with a node of the carrier network. Specifically, a system 410 includes a carrier network 412 having a plurality of nodes 414, a first technical nutrient redistribution network 420 and a second technical nutrient redistribution network 430. The first technical nutrient redistribution network 420 is associated with a first technical nutrient material and includes a plurality of geographically separated intake nodes 422. The second technical nutrient redistribution network 430 is associated with a second technical nutrient material and includes a plurality of geographically separated intake nodes 432. At least one intake node of the plurality of intake nodes 422 is co-located with a node 414 of the carrier network 412 at co-location 418, and at least one intake node of the plurality of intake nodes 432 is co-located with the same node 414 at co-location 418.

A method of transporting a first article from a first node 414 to a recipient location 416 and picking up a second and third article from the recipient location 416 is the same as with the previous embodiment. In this embodiment, however, the second article is transferred to an intake node 422 of the technical nutrient redistribution network 420 associated with that article at the co-location 418, and the third article is transferred to an intake node 432 of the technical nutrient redistribution network 430 associated with that article at the co-location 418.

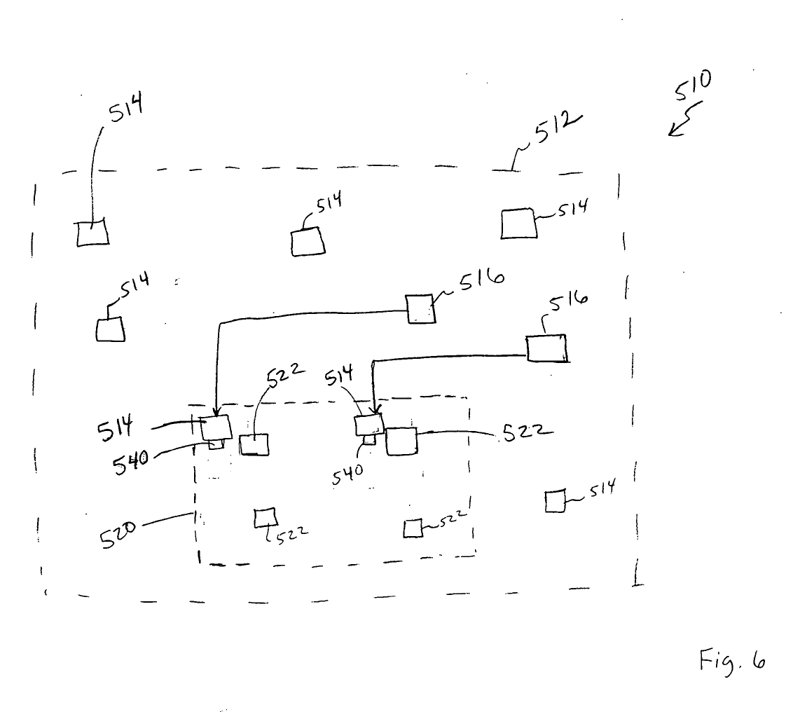

FIG. 6 illustrates a system and method according to another embodiment of the invention. A system 510 includes a carrier network 512 having a plurality of nodes 514 and at least one technical nutrient redistribution network 520 having a plurality of geographically separated intake nodes 522. In this embodiment, at least two nodes 514 of the carrier network 512 are each associated with an intake node 522 of the technical nutrient redistribution network 520. For example, a container 540 is located at each node 514 associated with the intake nodes 522. In some embodiments, the intake nodes 522 associated with the at least two nodes 514 of the carrier network 512 are co-located with the at least two nodes 514 of the carrier network 512. In some embodiments, at least two nodes 514 of the carrier network 512 are each associated with an intake node of a first technical nutrient redistribution network 520 and also an intake node of a second technical nutrient redistribution network (not shown).

As with the previous embodiments, a carrier driver transports, via a carrier vehicle, articles of mail from a node 514 to a recipient location 516. The driver picks up from the recipient location 516 another article and transports it back to the node 514 from which it started. In this embodiment, when an article is brought back to the node 514 from which the driver started, the article is placed in a container 540. The container 540 and its contents can be retrieved by a vehicle associated with the technical nutrient reprocessing network 520. Alternatively, the container 540 and its contents can be transported by a carrier vehicle to an intake node 522 of the technical nutrient redistribution network 520.

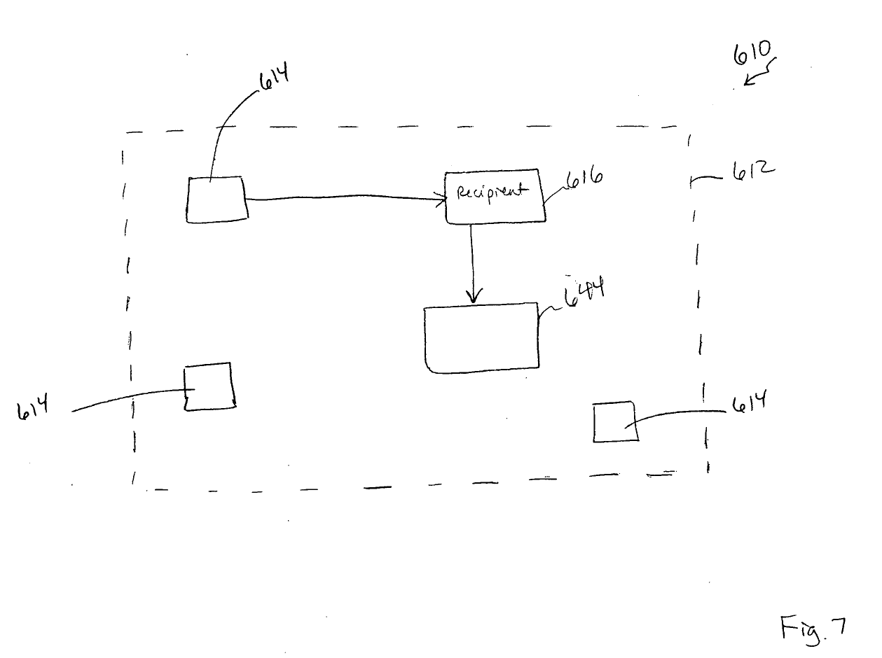

FIG. 7 illustrates yet another embodiment of the invention. A system 610 includes a carrier network 612 having a plurality of nodes 614 and a collection facility 644 In this embodiment, a carrier driver transports a first article of mail, via a vehicle, to a recipient location 516. The carrier driver picks up a second article from the recipient location 516 and transports it directly to a collection facility 644. The collection facility can be, for example, an intake node of a technical nutrient redistribution network.

In all of the embodiments described above, after an article has been placed at an intake node of a redistribution network or a collection facility there are a variety of possible next locations where the article can be transferred. At an intake node of a redistribution network or a collection facility, the articles can be sorted based on the type of product and/or type of materials for which they are constructed, or based on any other sorting or categorizing technique. An article can be disassembled to separate components and/or types of materials. Articles can then be transferred to a variety of possible locations. For example, an article can be transferred to a retail network or entity that is in the business of selling used articles, such as eBay, thrift shops, second-hand retail stores, and the like. An article can be transferred to a charitable organization for redistribution. An article can be sent to a recycling/reprocessing facility to be processed for reuse in some other product. An article can be sent to a manufacturer of like articles for refilling, replenishing, refurbishing, recycling, and/or reprocessing.

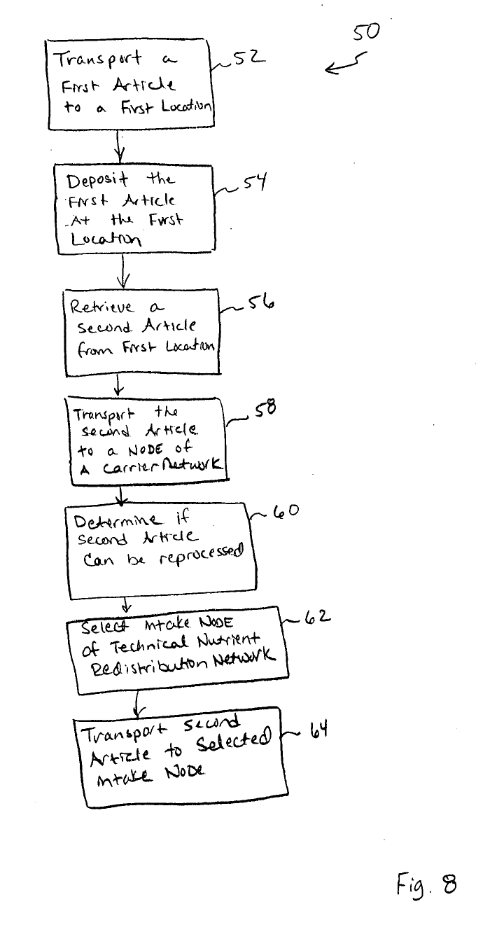

To summarize the above described systems and methods, a method of redistribution of an article of commerce is illustrated in a flow chart in FIG. 8. A method 50 includes transporting with a carrier vehicle to a first location a first article addressed to a recipient associated with the first location, at step 52. The first article is deposited at the first location at step 54. For example, the first article is placed in an authorized or legally protected mail box associated with the recipient location. A second article is retrieved from the recipient location, at step 56. The second article is, for example, a physical article of commerce including a technical nutrient material. The second article is transported with the vehicle to a node of a carrier network (e.g., a mail delivery network) at step 58. A node is, for example, a post office. At the node, a determination can be made as to whether the technical nutrient associated with the second article can be reprocessed at step 60, and if so, selecting which one of a plurality of geographically separated intake nodes of a redistribution network to transfer the second article, at step 62. The second article is then transported via the carrier network to the selected one of a plurality of geographically separated intake nodes of a technical nutrient redistribution network, at step 64. The selected intake node of the redistribution network can, in some embodiments, be co-located with the node of the carrier network.

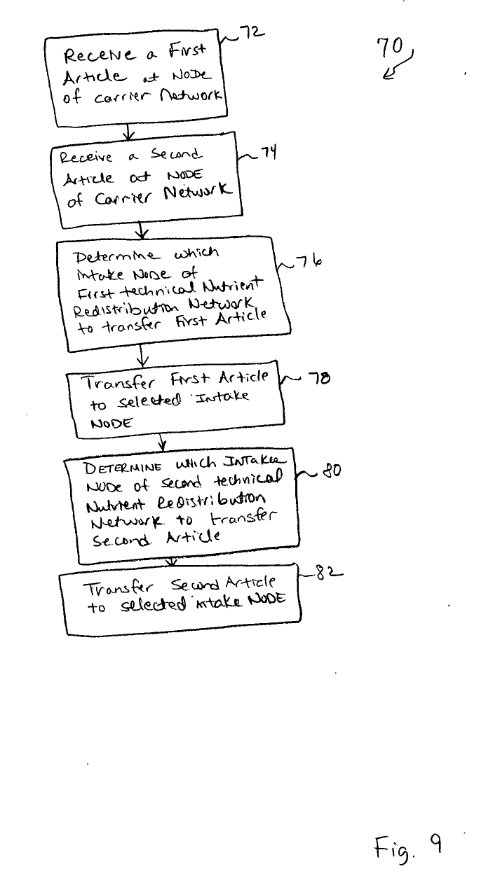

In another embodiment illustrated in FIG. 9, a method 70 includes receiving a first article including a first technical nutrient at a node in a common carrier distribution network, at step 72. The node can be, for example, a local post office or a concentration node, such as a state post office, a regional post office or other sorting facility. A second article, including a second technical nutrient, is received at the node at step 74. The first technical nutrient can be the same as the second technical nutrient, or the first technical nutrient can be different than the second technical nutrient. A determination is made as to which one of a plurality of intake nodes of a first technical nutrient distribution network associated with the technical nutrient of the first article that the first article should be transferred, at step 76. The first article is then transferred to the selected intake node of the first technical nutrient distribution network at step 78. A determination is made as to which one of a plurality of intake nodes of a second technical nutrient distribution network associated with the technical nutrient of the second article that the second article should be transferred, at step 80. The second article is then transferred to the selected intake node of the second technical nutrient distribution network at step 82. At the node in the common carrier distribution network, the first article and the second article can be sorted based on the type of technical nutrient each includes prior to transferring the first article and to transferring the second article. In addition, the determinations as to which intake node to transfer each of the articles can be based at least in part on a cost associated with transferring the articles to the intake node.

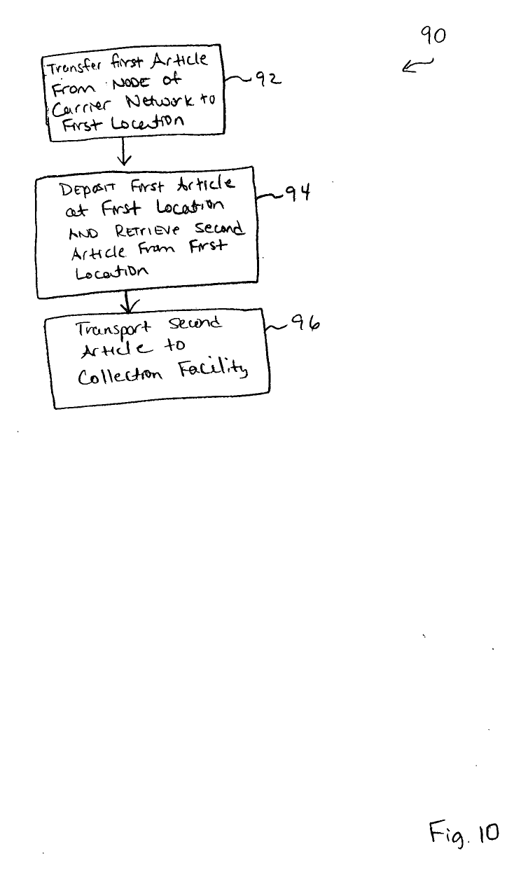

In another embodiment illustrated in FIG. 10, a method 90 includes transporting with a vehicle from a node of a carrier network to a first location, a first article addressed to a recipient associated with the first location, at step 92. The first article is deposited at the first location and a second article that includes a technical nutrient is retrieved from the first location, at step 94. The second article is transported with the vehicle to a collection facility at step 94.

In addition to articles including a technical nutrient material, all of the above-described systems and methods can be utilized to transport an article including a biological nutrient and/or an article including both a technical nutrient material and a biological nutrient and/or an article including a bio-technical material. Thus, the embodiments described above and illustrated in the figures are also applicable to the reverse logistics and redistribution of articles including a material composition other than a technical nutrient material. Redistribution networks associated with other materials can be configured and operate in the same manner as described in the above previously described embodiments.

A redistribution network for an article including a biological material may include a location or facility where the article can naturally biodegrade. For example, a greeting card constructed with a biological nutrient material can be placed in a user's mailbox or other designated location at the user's residence or business. A carrier can pick up the greeting card after dropping off an article of mail at the user's location and transport the greeting card to a node of a mail delivery network where it can eventually be transferred to a biological redistribution network in the same manner as described above for an article including a technical nutrient.

An intake node of a redistribution network associated with a biological nutrient material may transport or make available the article to a facility where the article can be placed in a suitable location to naturally biodegrade. Alternatively, the intake node may include a location where the article can be placed to biodegrade.

Similarly, articles including both a technical nutrient material and a biological nutrient material can be transported to an intake node of a redistribution network associated with handling such articles. Such a redistribution network may include facilities where the articles can be processed such that the biological nutrient material components are separated from the technical nutrient material components. The separated components of the articles can then be redistributed to an appropriate redistribution network associated with that material and/or type of article. In addition, some articles may include a bio-technical material. With such articles, the articles can be transferred to either a technical nutrient redistribution network or a biological nutrient redistribution network associated with that material and/or type of article.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents.

1. A method, comprising:
transporting with a vehicle to a first location a first article addressed to a recipient associated with the first location;
depositing the first article at the first location;
retrieving from the first location a second article that includes a technical nutrient;
transporting the second article with the vehicle to a node of a mail delivery network; and
transporting the second article via the mail delivery network to a selected one of a plurality of geographically separated intake nodes of a technical nutrient reprocessing network.

2. The method of claim 1, wherein the selected intake node of the reprocessing network is co-located with the intake node of the mail delivery network.

3. The method of claim 1, further comprising:
determining that the technical nutrient can be reprocessed by the technical nutrient reprocessing network.

4. The method of claim 1, further comprising:
selecting the one of the plurality of geographically separated intake nodes prior to the transporting the second article via the mail delivery network.

5. A method, comprising:
receiving a first article including a first technical nutrient at a node in a common carrier distribution network;
receiving a second article including a second technical nutrient at the node;
determining to which one of a plurality of intake nodes of a first technical nutrient distribution network associated with the technical nutrient of the first article the first article should be transferred;
transferring the first article to the selected intake node of the first technical nutrient distribution network;
determining to which one of a plurality of intake nodes of a second technical nutrient distribution network associated with the technical nutrient of the second article the second article should be transferred; and
transferring the second article to the selected intake node of the second technical nutrient distribution network.

6. The method of claim 5, wherein the determining for the first article is based at least in part on a cost associated with transferring the first article to the node of the first technical nutrient distribution network.

7. The method of 5, further comprising:
at the node in the common carrier distribution network, sorting the first article and the second article based on the first technical nutrient and the second technical nutrient prior to transferring the first article and to transferring the second article.

8. The method of claim 5, wherein the first technical nutrient is different than the second technical nutrient.

9. The method of claim 5, wherein the selected intake node of the first technical nutrient distribution network and the selected intake node of the second technical nutrient distribution network are each substantially co-located with the node in the common carrier distribution network.

10. The method of claim 5, wherein the node in the common carrier distribution network is one of a plurality of nodes in the common carrier distribution network, each of the nodes being co-located with an intake node of at least one of the first technical nutrient distribution network and the second technical nutrient distribution network.

11. The method of claim 5, wherein the node in the common carrier distribution network is a concentration node.

12. A method, comprising:
receiving an article including a technical nutrient at one of a plurality of distribution nodes associated with a common carrier; and
delivering the article to a selected one of a plurality of intake nodes of a technical nutrient distribution network associated with the technical nutrient of the article, the plurality of intake nodes being geographically separated within the technical nutrient distribution network.

13. The method of claim 12, wherein the selected one of a plurality of intake nodes is selected based on a cost associated with delivery of the article to the intake node.

14. The method of claim 12, wherein the selected node of the plurality of intake nodes is co-located with the one node of the plurality of distribution nodes associated with the common carrier.

15. The method of 12, further comprising:
prior to the receiving the article, collecting the article from an end user using a vehicle associated with the common carrier.

16. A system, comprising:
a distribution network associated with a common carrier including a plurality of nodes, the plurality of nodes being configured to receive and disperse articles, at least two nodes of the plurality of nodes each being associated with an intake node of a technical nutrient reprocessing network, the technical nutrient reprocessing network having a plurality of geographically separated intake nodes.

17. The system of claim 16, wherein each of the at least two nodes includes a collection container configured to receive a plurality of articles, each of the plurality of articles including a technical nutrient reprocessable by the technical nutrient reprocessing network.

18. The system of claim 16, wherein the technical nutrient reprocessing network is a first technical nutrient reprocessing network and is capable of reprocessing a first technical nutrient, each of the at least two nodes of the plurality of nodes also being associated with an intake node of a second technical nutrient reprocessing network, the second technical nutrient reprocessing network being capable of reprocessing a second technical nutrient different from the first technical nutrient.

19. A method, comprising:
transporting with a vehicle from a node of a mail delivery distribution network to a first location a first article addressed to a recipient associated with the first location;
depositing the first article at the first location;
retrieving from the first location a second article that includes a technical nutrient; and
transporting the second article with the vehicle to a collection facility.

20. The method of claim 19, wherein the collection facility is configured to sort a plurality of articles and send each one of the plurality of articles to a selected one of a plurality of processing nodes within a redistribution network based on the sorting.

21. The method of claim 19, wherein the plurality of processing nodes includes at least one of an electronic commerce outlet, a recycling processor, a manufacturer of articles of a type of at least one of the plurality of articles, a charitable organization, or a retail sales outlet.

22. The method of claim 19, wherein the second article includes a technical nutrient.

23-34. (canceled)
